(19) United States
(12) Patent Application Publication
(10) Pub. No.: US 2018/0225683 A1
(43) Pub. Date: Aug. 9, 2018

(54) SYSTEMS AND METHODS FOR TAGGING TRANSACTIONS WITH EMOTIONS

(71) Applicant: JPMorgan Chase Bank, N.A., New York, NY (US)

(72) Inventors: Matthew Gromada, New York, NY (US); Amanda Valladares, Brooklyn, NY (US); Amanda Smith, Brooklyn, NY (US); Melora Zaner, New York, NY (US); Jay E. Parsons, Columbus, OH (US); Jonathan Beck, New York, NY (US); Erika Scott, Brooklyn, NY (US); Claudio Esposito, New York, NY (US); Indeevara H. De Silva, Lewis Center, OH (US); Melissa Feldsher, New York, NY (US); Geoffrey L. Goetz, Hilliard, OH (US); Michael Thornton, Westerville, OH (US); Kimberly Chan, New York, NY (US)

(21) Appl. No.: 15/890,420

(22) Filed: Feb. 7, 2018

Related U.S. Application Data
(60) Provisional application No. 62/455,893, filed on Feb. 7, 2017.
(60) Provisional application No. 62/482,345, filed on Apr. 6, 2017.
(60) Provisional application No. 62/543,904, filed on Aug. 10, 2017.

(51) Int. Cl. G06Q 30/02; G06Q 20/40

(52) U.S. Cl. CPC G06Q 30/0201; G06Q 20/40145

(57) ABSTRACT

Systems and methods for tagging transactions with emotions are disclosed. According to one embodiment, in an information processing device comprising at least one computer processor, a method for associating an emotion with a transaction may include: (1) receiving, at a computer application executed by the computer processor, transaction information for a transaction conducted by a user; (2) presenting at least a portion of the transaction on a display of the information processing device and a plurality of icons, each icon representing an emotion, to associate the transaction with; (3) receiving a selection of one of the plurality of icons; and (4) associating the transaction with the emotion associated with the selected icon.

### RELATED APPLICATIONS

This application claims priority to U.S. Provisional Patent Application Ser. No. 62/455,893, filed Feb. 7, 2017, U.S. Provisional Patent Application Ser. No. 62/482,345, filed Apr. 6, 2017 and U.S. Provisional Patent Application Ser. No. 62/543,904, filed Aug. 10, 2017. The disclosures of each of these documents is hereby incorporated, by reference, in its entirety.

### BACKGROUND OF THE INVENTION

### 1. Field of the Invention

The present disclosure generally relates to systems and methods for tagging transactions with emotions.

### 2. Description of the Related Art

After conducting transactions, individuals may tag transactions, such as expenses, with an expense category (e.g., transportation, dining, entertainment, etc.) or a transaction type. For some individuals, this may not necessarily tell the whole story of the transaction; there is often an emotional component in conducting a transaction that may provide insight into an individual's spending habits.

### SUMMARY OF THE INVENTION

System and methods for tagging transactions with emotions are disclosed. According to one embodiment, in an information processing device comprising at least one computer processor, a method for associating an emotion with a transaction may include: (1) receiving, at a computer application executed by the computer processor, transaction information for a transaction conducted by a user; (2) presenting at least a portion of the transaction on a display of the information processing device and a plurality of icons, each icon representing an emotion, to associate the transaction with; (3) receiving a selection of one of the plurality of icons; and (4) associating the transaction with the emotion associated with the selected icon.

In one embodiment, the display may include a touch-sensitive screen, and the selection of the icon is received as a gesture on the touch-sensitive screen.

In one embodiment, each icons may include an emoji.

In one embodiment, the method may further include receiving a selection of a necessity of the transaction, wherein the necessity comprises a want or a need for the transaction, and associating the selection of the necessity with the transaction. In one embodiment, the selection of the icon and the necessity is received as a single gesture on the touch-sensitive screen.

In one embodiment, the gesture may be a swipe.

In one embodiment, the method may further include highlighting one of the plurality of icons with an anticipated selection based on at least one prior transaction.

According to another embodiment, in a mobile electronic device comprising at least one computer processor, a method for associating an emotion with a transaction may include: (1) receiving, at a computer application executed by the computer processor, a request to conduct a transaction; (2) receiving at least one biometric from a user associated with the electronic device; (3) identifying an emotional state associated with the biometric; and (4) associating the transaction with the emotion.

In one embodiment, the biometric may include a pulse, a facial feature, a voice, etc.

In one embodiment, the method may further include authenticating the user to conduct the transaction based on the biometric.

In one embodiment, the method may further include receiving a selection of a necessity of the transaction, wherein the necessity comprises a want or a need for the transaction; and associating the selection of the necessity with the transaction.

In one embodiment, the method may further include associating the transaction with additional data comprising at least one of a time of day/month/year for the transaction, an environmental condition for the transaction, and a geographical location of the transaction. The additional data may be received from a third party.

According to another embodiment, in an information processing apparatus comprising at least one computer processor a method for processing a plurality of transactions that have each been associated with an emotion may include: (1) receiving a plurality of transactions for a user, each transaction associated with an emotion and a necessity; (2) evaluating the transactions to identify a transaction type that is emotionally satisfying to the user, wherein emotionally satisfying transactions have a satisfaction level based on the emotion and the necessity based on the transaction; and (3) providing a recommendation of at least one future transaction that will be emotionally satisfying based on the evaluation.

In one embodiment, the future transaction may be based on a prior transaction, a transaction conducted by a similarly-situated individual, a customer graph, etc.

In one embodiment, the method may further include identifying at least one emotional spending trend based on the transactions; and presenting the emotional spending trend to the user.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for tagging transactions with emotions according to one embodiment;

FIG. 2 depicts a method for tagging transactions with emotions according to one embodiment; and

FIGS. 3A and 3B depict exemplary graphical user interfaces according to one embodiment.

### DETAILED DESCRIPTION OF PREFERRED EMBODIMENTS

This disclosures of U.S. Provisional Patent Application Ser. No. 62/455,893, filed Feb. 7, 2017 and U.S. Provisional Patent Application Ser. No. 62/454,376, filed Feb. 3, 2017 are hereby incorporated, by reference, in their entireties.

Embodiments disclosed are generally directed to rating, tagging, or associating a transaction with an emotion. For example, the transaction may be tagged with an emotion that represents how the transaction made the individual feel, such as happy, sad, upset, anxious, neutral, etc. In one embodiment, icons, such as emoji icons, may be used to select the emotion to tag with the transaction.

In embodiments, transactions may be further tagged with a necessity, such as whether the transaction was a “want” (e.g., optional) or a “need” (e.g., unavoidable) transaction. The tagging of the necessity of the transaction may occur at the same time as the emotional tagging.

Based on the taggings, recommendations and insights on an individual's and/or a group's spending may be achieved. Such recommendations may present opportunities to save money, and/or to spend money in a manner that is emotionally satisfying to the individual. For example, recommendations on how to spend money in a more emotionally-satisfying manner may be provided. In addition, additional merchants, locations, items, etc. that other similarly-situated users have enjoyed may be identified.

Notably, different individuals may achieve satisfaction in different ways. Machine learning may be used to determine each individual's expected emotional response to a transaction, and make recommendations on how to spend money in an emotionally-satisfying manner. For example, once a user has rated a number of transactions, machine learning may be used to predict how a user will rate future transactions. It may suggest a rating to the user, or it may rate the transaction automatically.

In one embodiment, the individual may use an application executed by a mobile electronic device (e.g., a smartphone, a tablet, etc.) to tag/rate/associate transactions. In another embodiment, the individual may use any other device, such as a notebook computer, desktop computer, Internet of Things (IOT) appliance, etc.

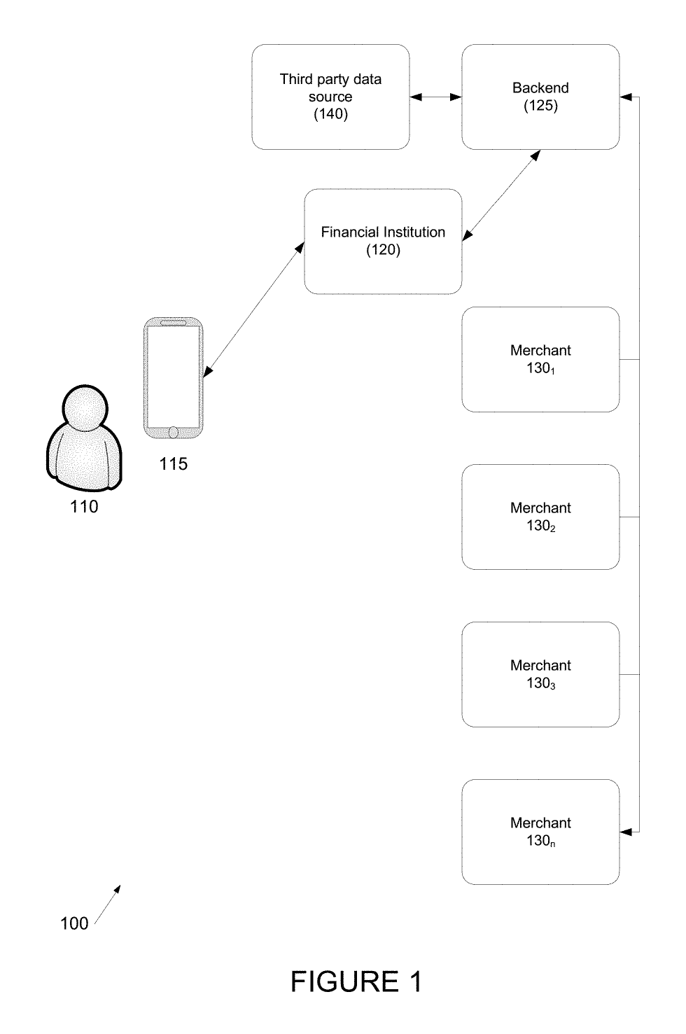

Referring to FIG. 1, a system for tagging transactions with emotions is disclosed according to one embodiment. System 100 may include individual 110 that may use electronic device 115. Electronic device 115 may include, for example, mobile electronic devices (e.g., smartphones, tablet computers, etc.), Internet of Things (IoT) appliances, notebook computers, desktop computers, etc.

Individual 110 may interact with one or more of merchants 130₁, 130₂, . . . 130ₙ. Merchants 130 may be any entity that may receive a payment from individual 110, including, for example, individuals, providers of goods or services (e.g., brick and mortar merchants, online merchants), government agencies, etc. In one embodiment, individual 110 may conduct a transaction with merchant 130 using a credit card or other payment instrument; in another embodiment, individual 110 may conduct a transaction with merchant 130 using mobile device 115.

In one embodiment, individual 110 may have one or more accounts with financial institution 120, such as a savings account, a checking account, a credit card account, etc. Electronic device 115 may execute one or more computer programs or applications (not shown) that may interact with financial institution 120 and/or backend 125. For example, electronic device 115 may execute a computer program or application to facilitate tagging one or more transaction with an emotion.

In one embodiment, third party data source 140 may be provided. Third party data source 140 may provide data that may be used to enhance transaction data. Examples of data provided by third party data source 140 may include weather data, calendar data, etc.

In one embodiment, financial institution 120 may also provide data that may be used to enhance transaction data. For example, information on other accounts, balances, purchases, etc. may be used as is necessary and/or desired.

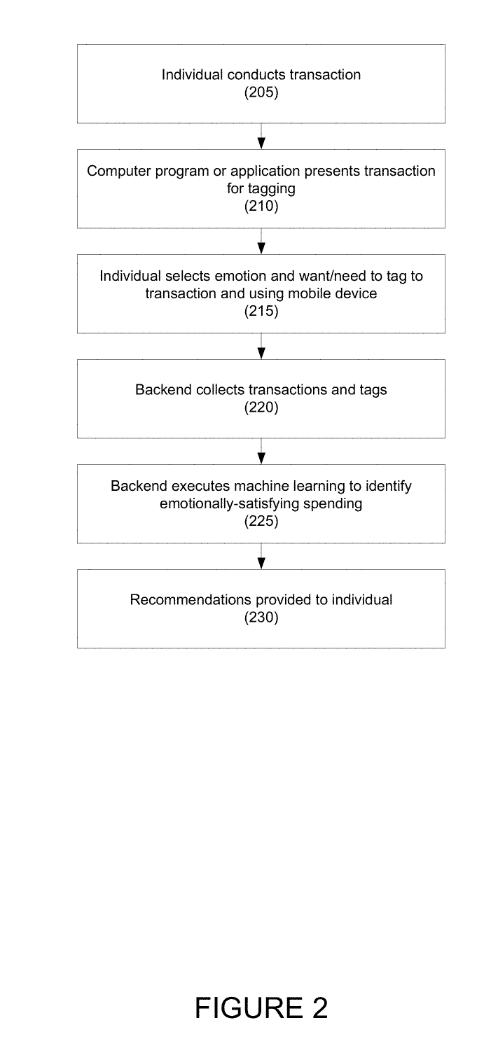

Referring to FIG. 2, a method for tagging transactions with emotions is disclosed according to one embodiment.

In step 205, an individual may conduct a transaction for a good or service. The transaction may be conducted, for example, using a credit card, using a check, using cash, using a mobile payment application (e.g., ChasePay, ApplePay, Samsung Pay, etc.), as an on-line transaction, etc. In one embodiment, the transaction may be conducted by the individual, or it may be a scheduled transaction (e.g., scheduled bill pay).

In step 210, a computer program or application may present the transaction(s) to the individual for tagging. In one embodiment, the individual may rate the transactions using a graphical user interface provided, for example, on a mobile electronic device. In one embodiment, the individual may be presented with money-out transactions (e.g., POS/Online Debit Transactions, ACH Debit Transactions, Bill Pay Transaction, P2P Debit Transaction).

For example, when the individual accesses the transaction tagging feature, the individual may see all untagged pending and posted transactions that are eligible to be tagged. These may be presented, for example, in reverse chronological order starting with the most recent and going back a certain period of time.

If the individual has unrated transactions, the individual may receive a reminder, such as a push reminder, a reminder in the program/application, etc.

In one embodiment, an individual may skip rating a transaction, or may choose to rate the transaction at a later time.

In step 215, the individual may “rate” the transaction based on the emotional response that the user at the time of transaction, or subsequent to conducting the transaction. For example, the user may identify whether the transaction makes the user happy, neutral, sad, angry, or any other emotion as is necessary and/or desired. In one embodiment, the user may select an icon (e.g., an emoji) that is associated with the emotion. In another embodiment, the individual may select the emotion from a drop down list. In still another embodiment, the individual may manually enter the emotion.

Other examples of emotions that may be associated with a transaction may include happy, sad, neutral, relieved, anxious, positive, negative, etc.

In one embodiment, the emotions may be pre-defined; in another embodiment, the individual may define or select emotions as is necessary and/or desired.

In one embodiment, the individual may also tag the transaction with either a “want” or “need” tag. For example, “want” tags may be associated with transactions that are not necessary (e.g., premium coffee), whereas “need” transactions may be associated with transactions that are necessary (e.g., transportation expenses, living expenses, etc.).

In one embodiment, the transaction may be assigned a transaction. Example categories include Bills & Utilities; Education; Food & Drink; Fun/Entertainment; Gas; Groceries; Health & Wellness; Home; Personal; Pets; Shopping; Transportation; Travel; Uncategorized; Cash; Income; and Transfer.

In addition, the user may rate the underlying transaction itself. This may include rating the transaction based on, for example, the price, value, experience, etc. for the transaction. This may provide additional insight regarding spending habits (e.g., the individual is happy when the individual gets a good deal on a “need” item).

In one embodiment, the transaction may be rated at the time of the transaction. For example, the application may recognize a transaction and may push a notification to the individual to rate the transaction. In another embodiment, the transaction may be rated subsequent to the transaction. For example, transactions may be rated periodically (e.g., weekly, monthly, etc.).

In still another embodiment, the individual may change the associated emotion with a transaction subsequent to the tagging.

In one embodiment, the individual may manually enter a transaction and then tag the transaction. This may be used, for example, for cash transactions.

In one embodiment, biometrics may be used to rate the transactions at the time the transaction takes place. For example, a camera on the individual's mobile electronic device may capture the user's facial expression at the time of transaction and may detect an emotion associated with the transaction. In one embodiment, the individual may train the system to detect the appropriate emotion.

In another example, a camera on the user's mobile electronic device (e.g., smartphone) may use the individual's pulse to identify an emotion to associate with the transaction. For example, the individual's pulse may be detected by the camera from, for example, the individual's face, finger, etc. In another embodiment, the individual's pulse may be received from a wearable device (e.g., a fitness tracking device with a heart rate sensor). In another embodiment, the individual's pulse may be detected during biometric authentication for the transaction (e.g., when the individual uses a fingerprint to authenticate the user to conduct a transaction, the individual's pulse may be detected). Other manners of receiving biometrics may be used as is necessary and/or desired.

In one embodiment, the transactions may be enriched with additional data, such as the time of day/month/year when the transaction occurred, environmental conditions (e.g., temperature, weather, etc.), the geographical location of the transaction, the individual's status (e.g., work, vacation, etc.), etc. In one embodiment, enrichment data may be received from external sources, such as weather sources, the individual's calendar, etc.

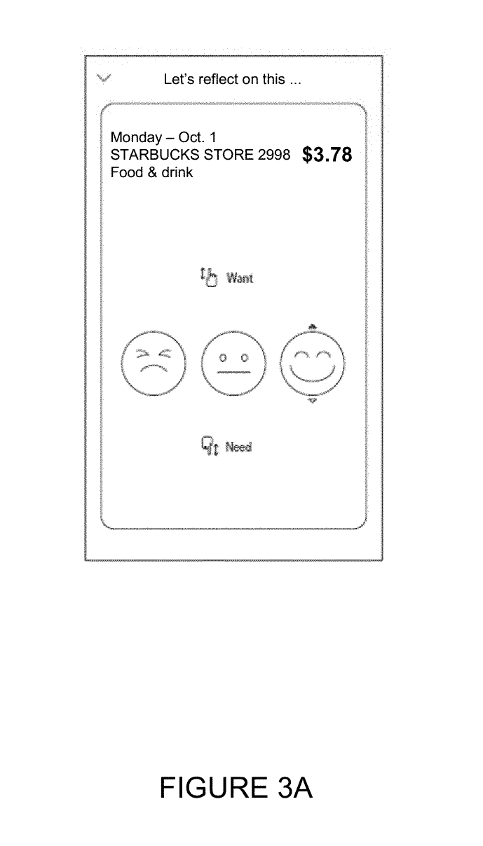

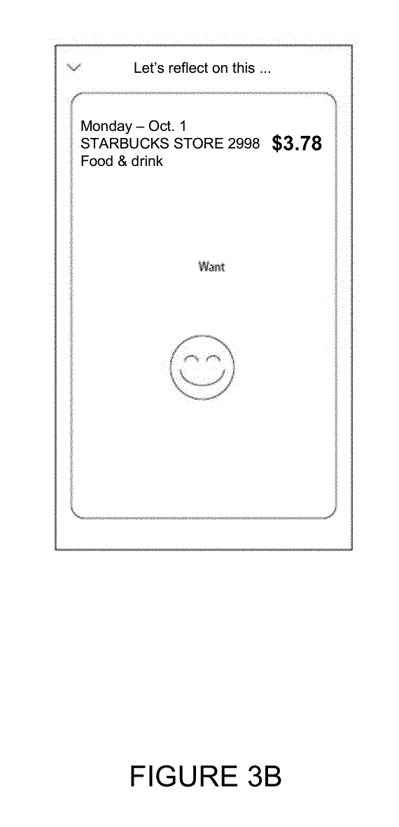

Referring to FIG. 3A, an exemplary screenshot of a tagging interface is provided according to one embodiment. In one embodiment, three emotions may be provided (e.g., sad, neutral, happy); additional or fewer emotions may be provided as is necessary and/or desired. In addition, the user may indicate a “want” or “need” transaction by swiping in an upward direction or in a downward direction, respectively. Thus, by selecting an icon and swiping upward or downward, the user may quickly tag the transaction with the emotion associated therewith, as well as whether it was a want or need transaction. It should be noted that this interface is exemplary only and other manners of indicating “want” or “need” may be used as is necessary and/or desired.

In one embodiment, machine learning may be used to highlight an expected response based on past transaction tagging, the individual's financial situation, etc. For example, if the individual has tagged coffee purchases as “happy/want” in the past, the happy icon and the want icon may be highlighted for the user. The individual may still tag the transaction as normal, but may also be presented with a confirm icon (not shown) to rapidly confirm the pre-selection.

In one embodiment, machine learning may be used to automatically tag transactions based on past transactions.

After tagging the transaction with the emotion and want/need, the computer program/application may present a confirmation screen. An exemplary screen is provided in FIG. 3B.

In one embodiment, the user may tag transactions with an emotion and/or necessity from, for example, the user's checking account transaction history, credit card history, etc. For example, using a computer application for the financial institution, the user may select a line item and may tag it with the desired emotion and/or necessity.

In one embodiment, the user may chose an individual transaction from the user's checking account history, credit card history, etc. and may edit the tagging from within the transaction details.

Referring again to FIG. 2, in step 220, the backend may receive the tagging(s) from the program/application executed by the electronic device. In one embodiment, the backend may receive the tags as the transactions are tagged; in another embodiment, the backend may receive the tags periodically in a batch (e.g., daily, weekly, monthly etc.), at the conclusion of a “tagging” session, etc.).

In step 225, the backend may execute a machine learning program based on the individual's emotional tagging. For example, after a certain number of transactions, the backend may determine the types of transactions that are emotionally satisfying for the individual. It may further provide a summary of spending by emotion, the transactions for each emotion, trends, etc. may be used to set budgeting and/or saving goals.

In step 230, the backend may provide recommendations and analysis to the user via the electronic device. For example, in one embodiment, spending trends may be provided that may assist the individual come to conclusions regarding the individual's spending.

In one embodiment, the backend may provide recommendations on how an individual may spend less, or may optimize spending in an emotionally-satisfying way. In one embodiment, this may be based on the individual's spending trends.

For example, in one embodiment, the backend may provide emotional trends for the user. For example, the backend may aggregate and illustrate the emotional ratings in a graph and/or chart. In one embodiment, in addition to providing an aggregate spend, the users may also select one of the emotions (e.g., an emoji) and may view transactions and transaction details associated with that emotion.

In one embodiment, the backend may provide wants/needs trends for the user. For example, it may aggregate wants/needs and illustrate these to the user in a graph and/or chart. In addition to an aggregated spend, the user may select a merchant category and view transaction details for that merchant category.

In one embodiment, each transaction may be associated with a satisfaction level which may be based on the associated emotion and the associated necessity (e.g., want or need). In one embodiment, the satisfaction level for one transaction may be based on satisfaction levels for at least one other transaction.

In one embodiment, augmented reality may be used to provide recommendations to the individual. For example, a combination of the individual's mobile device camera and location-sensing technology may be used to present spending information to the individual as the camera detects different merchants. If the camera detects a merchant at which the individual has had unsatisfactory emotional transactions, a message to that effect may be presented to the individual.

Augmented reality may be presented on the mobile electronic device, on smart glasses, etc.

In one embodiment, the backend may provide recommendations based on similarly-situated individuals. For example, the recommendations may be based on averaged data from other similarly-situated individuals and may assist in decision making. Customer graphs may be used to provide such recommendations and/or insights. Example customer graphs are disclosed in U.S. Patent Application Ser. No. 62/134,959 and U.S. patent application Ser. No. 14/878,395, the disclosures of which are hereby incorporated by reference in their entireties.

In one embodiment, the backend may provide auto-save rules that may assist the individual in saving money. The rules may be based, for example, on transaction types and/or emotion associated with the transaction. Any suitable trigger may be used.

In one embodiment, the backend may provide budgeting information to the user based on emotions or wants/needs. For example, the budgeting tool may help the user change his or her behavior by, for example, reducing “want” spending, increasing “happy” spending, etc. It may further encourage the user to set a monthly or weekly target spend for those spends, and may determine a budget based on past transactions, income, savings, etc.

In one embodiment, the user may be presented with challenges (e.g., weekly, monthly, etc.) in which the user may be rewarded with, for example, points toward a game, badge, etc. that may be provided in the computer application.

In one embodiment, the backend may provide support notifications. The rules may be based, for example, on spending habits, balance, etc.

In embodiments, the backend may provide reports, such as a monthly spend summary, a wants/needs summary, transactions are presented based on associated emoji's, emotion-based transaction, monthly spend using an emotion pie chart, alternative spending suggestions, recommendations on future spending, a spending recommendation based on emotions, a location-based notification, savings recommendations, etc.

In one embodiment, individuals may share non-financial data with others in their social networks, such as reaching a savings goal.

Other embodiments may include, for example, a service that shows different travel options based on the money that the individual has; personalized savings goals that the individual can change over time; a tool that explores different ways for the individual to spend money (e.g., going to grad school, moving, etc.); a service that matches the individual to a cause and volunteer opportunities in the individual's area; a service that allows a community to pool money for a cause; a bank message board that shares life “pro tips” and “saving hacks” from similarly-situated individuals.

In one embodiment, a financial institution may aggregate data from a plurality of individuals. In one embodiment, the financial institution may remove all personally identifiable information and may provide this information to third parties (e.g., to merchants) so that the merchants can see the emotional response associated with their goods or services.

It should be noted that the embodiments disclosed herein are not exclusive, and different features and aspects one embodiment may apply to others.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for associating an emotion with a transaction, comprising:
in an information processing device comprising at least one computer processor:
receiving, at a computer application executed by the computer processor, transaction information for a transaction conducted by a user;
presenting at least a portion of the transaction on a display of the information processing device and a plurality of icons, each icon representing an emotion, to associate the transaction with;
receiving a selection of one of the plurality of icons; and
associating the transaction with the emotion associated with the selected icon.

2. The method of claim 1, wherein the display comprises a touch-sensitive screen, and the selection of the icon is received as a gesture on the touch-sensitive screen.

3. The method of claim 1, wherein each icons comprises an emoji.

4. The method of claim 1, further comprising:
receiving a selection of a necessity of the transaction, wherein the necessity comprises a want or a need for the transaction; and
associating the selection of the necessity with the transaction.

5. The method of claim 4, wherein the display comprises a touch-sensitive screen, and the selection of the icon and the necessity is received as a single gesture on the touch-sensitive screen.

6. The method of claim 5, wherein the gesture comprises a swipe.

7. The method of claim 1, further comprising:
highlighting one of the plurality of icons with an anticipated selection based on at least one prior transaction.

8. A method for associating an emotion with a transaction, comprising:
in a mobile electronic device comprising at least one computer processor:
receiving, at a computer application executed by the computer processor, a request to conduct a transaction;
receiving at least one biometric from a user associated with the electronic device;
identifying an emotional state associated with the biometric; and
associating the transaction with the emotion.

9. The method of claim 8, wherein the biometric comprises a pulse.

10. The method of claim 8, wherein the biometric comprises a facial feature.

11. The method of claim 8, wherein the biometric comprises a voice.

12. The method of claim 8, further comprising:
authenticating the user to conduct the transaction based on the biometric.

13. The method of claim 8, further comprising:
receiving a selection of a necessity of the transaction, wherein the necessity comprises a want or a need for the transaction; and
associating the selection of the necessity with the transaction.

14. The method of claim 8, further comprising:
associating the transaction with additional data comprising at least one of a time of day/month/year for the transaction, an environmental condition for the transaction, and a geographical location of the transaction.

15. The method of claim 14, wherein the addition data is received from a third party.

16. A method for processing a plurality of transactions that have each been associated with an emotion, comprising:
in an information processing apparatus comprising at least one computer processor:
receiving a plurality of transactions for a user, each transaction associated with an emotion and a necessity;
evaluating the transactions to identify a transaction type that is emotionally satisfying to the user, wherein emotionally satisfying transactions have a satisfaction level based on the emotion and the necessity based on the transaction; and
providing a recommendation of at least one future transaction that will be emotionally satisfying based on the evaluation.

17. The method of claim 16, wherein the future transaction is based on a prior transaction.

18. The method of claim 16, wherein the future transaction is based on a transaction conducted by a similarly-situated individual.

19. The method of claim 16, wherein the transaction is based on a customer graph.

20. The method of claim 16, further comprising:
identifying at least one emotional spending trend based on the transactions; and
presenting the emotional spending trend to the user.
